(19) United States
(12) Patent Application Publication
(10) Pub. No.: US 2012/0044090 A1
(43) Pub. Date: Feb. 23, 2012

(54) MOTOR VEHICLE WITH DIGITAL PROJECTORS

(75) Inventors: Peter KAHLER, Nierstein (DE); Marten WITTORF, Ingelheim (DE); Joerg KATHMANN, Salzkotten (DE)

(73) Assignee: GM GLOBAL TECHNOLOGY OPERATIONS LLC, Detroit, MI (US)

(21) Appl. No.: 13/212,899

(22) Filed: Aug. 18, 2011

(30) Foreign Application Priority Data
Aug. 18, 2010 (DE) 102010034853.8

(51) Int. Cl. G08G 1/09

(52) U.S. Cl. 340/905

(57) ABSTRACT

A motor vehicle includes, but is not limited to a digital projector for projecting a graphic or type facial information and a monitoring circuit, to which the projector is connected, in order to project as the graphic or type facial information an information determined by the monitoring circuit in real time.

### CROSS-REFERENCE TO RELATED APPLICATION

This application claims priority to German Patent Application No. 102010034853.8, filed Aug. 18, 2010, which is incorporated herein by reference in its entirety.

### TECHNICAL FIELD

The technical field relates to a motor vehicle with at least one digital projector for projecting a graphic or type facial information.

### BACKGROUND

A motor vehicle is known from DE 10 2006 036 061 A1. With this known vehicle the digital projector serves for illuminating a trunk or a floor area in front of an opened door of the vehicle. The benefit of the digital projector for a user lies in the illumination effect. The displayed information, a manufacturer's logo, has no useful value for the user whatsoever.

From U.S. Pat. No. 7,684,007 B2 the suggestion is known to employ a digital projector as headlamp of a motor vehicle. The headlamp beam created by such a digital projector can be imagined as a bundle of part beams each of which being controllable in its intensity through a matrix element of the digital projector. In that when oncoming traffic is sensed, part beams, which would hit an oncoming vehicle, are suppressed, dazzling of the driver of such a vehicle can be avoided and the surroundings of the oncoming vehicle still be illuminated with high intensity.

With this prior art, too, the driver of the vehicle equipped with the digital projector does not himself have any direct advantage. A gain in comfort for the driver substantially lies only in that he need not switch between high beam and low beam light so as not to dazzle oncoming traffic. However, this effect can be realized with substantially lower costs in that with a conventional lighting system that can be switched over between high beam and low beam light an automatic device assumes the task of switching between high beam and low beam light when oncoming traffic is sensed.

At least one object is to create a motor vehicle, wherein a built-in digital projector makes possible specifically for the driver a direct gain in comfort and/or safety. In addition, other objects, desirable features and characteristics will become apparent from the subsequent summary and detailed description, and the appended claims, taken in conjunction with the accompanying drawings and this background.

### SUMMARY

A motor vehicle is provided that has at least one digital projector for projecting a graphic or written information the projector is connected to a monitoring circuit of the vehicle in order to project as graphic or type-facial information an information determined by the monitoring circuit in real time. As such information, any information is possible in principle, which would be conventionally displayed on an instrument panel of the vehicle. However, it can also be practical to display information which is not normally visible on a display of the instrument panel, as will still be explained in more detail in the following.

Preferentially, the digital projector is aligned in order to project the information in a direction running away from a passenger cell of the vehicle so that said information is visible to the occupants of the vehicle when it strikes a suitable projection surface. Such a projection surface will generally be located outside the motor vehicle; more preferably it can be a roadway surface, a wall or the like. Practically, at least one headlamp and/or at least one rear spotlight of the vehicle can be designed as said digital projector in order to render the determined information visible on a surface lit up by the headlamp/spotlight.

If at least one headlamp and at least one rear spotlight are designed as digital projector, a control unit can be practically set up to select the headlamp for projecting the information when the vehicle moves forward or a forward gear is engaged, and to select the rear spotlight for projecting the information when the vehicle moves backwards or a reverse gear is engaged. Thus the probability is high that the information in each case is visible in the direction in which the driver of the vehicle happens to be looking.

According to an embodiment the information determined in real time is the distance of the vehicle from an obstacle. As monitoring circuit, more preferably a radar or laser distance finder can be considered in such a case.

According to another embodiment, the monitoring circuit can be a navigation system. The information determined and projected in real time is then preferentially driving direction information which draws the attention of the driver to a direction to be taken, imminent turning-off or the like. The navigation system however could still supply further information that can be derived from its map data, e.g., a speed restriction or the like dependent on the type of the road travelled on.

In order to be directly clear to the driver and without additional utilization of his attention it is practical if the projector is set up to project the information in the form of an image of a traffic sign. If the information concerns driving direction information, it can also be practical that the projector projects said information in the form of a lane marking.

The monitoring circuit can also be set up in order to sense in real time the degree of the attention of the driver; if this degree of attention undershoots a limit value an information in this regard is projected for example in the form of a graphic symbol which requests the driver to take a break.

According to a further embodiment the information determined by the monitoring circuit and projected by the projector can specify a restriction of the navigability of a road travelled on by the motor vehicle. The monitoring circuit in such a case practically comprises a camera and an image evaluation system for detecting traffic signs in the images supplied by the camera. The projected information can then be a copy of a previously detected restrictive traffic sign applicable to the road travelled on such as for example a speed restriction, an overtaking prohibition, information regarding a roadway narrowing, a right of way of the oncoming traffic or the like.

In order to avoid overloading the driver with information the monitoring circuit can be furthermore set up to evaluate if the vehicle is in the process of contravening a applicable restriction in order to project the information specifying the restriction only in the event of the contravention. In order to ensure that the projected information can be clearly perceived by the driver the motor vehicle can furthermore comprise means for detecting a vehicle-external projection surface and means for aligning the projection direction with a detected projection surface. Possible means for detecting such a projection surface are more preferably the already mentioned camera, the radar or laser distance measuring system.

The secure perception of the projected information by the driver can also be promoted through means for sensing the brightness of the projection surface and for controlling the light intensity, with which the graphic or type-facial information is projected, by means of the sensed brightness. The means for sensing the brightness can more preferably be the already mentioned camera and the image evaluation system connected with said camera. In that the image evaluation system determines the brightness of the projected information in the received image and if applicable readjusts the luminous intensity of the projector, a good and even detectability of the projected information on various projection surfaces with different brightness can be ensured.

If the projector in a manner known per se comprises a matrix with a plurality of individually activatable, light-modulating elements, the means for aligning the projection direction can be practically set up to select a group of these elements to be supplied with the graphic or type-facial information to be projected in accordance with a desired projection direction. Thus, the projected image can be placed clearly visibly without the alignment of the projector having to be changed for this purpose or optical components displacing the entire beam of the projector having to be moved.

If the information to be projected is the distance of the vehicle from an obstacle the means for aligning are practically set up in order to detect the obstacle concerned as projection surface. In this way, the determined distance becomes visible on the very obstacle to be observed in a manner directly suggestive to the driver. In addition to this, the possibility arises to simultaneously monitor the distance to a plurality of obstacles and make it easier to the driver to observe the determined distance values in that each of these are displayed on the obstacle to which they apply.

### BRIEF DESCRIPTION OF THE DRAWINGS

The present invention will hereinafter be described in conjunction with the following drawing figures, wherein like numerals denote like elements, and:

FIG. 1 is a block diagram of a motor vehicle according to an embodiment of the invention;

FIG. 2 is a first application situation of the motor vehicle;

FIG. 3 is a second application situation; and

FIG. 4 is a third application situation of the motor vehicle according to an embodiment of the invention.

### DETAILED DESCRIPTION

The following detailed description is merely exemplary in nature and is not intended to limit application and uses. Furthermore, there is no intention to be bound by any theory presented in the preceding background or summary or the following detailed description.

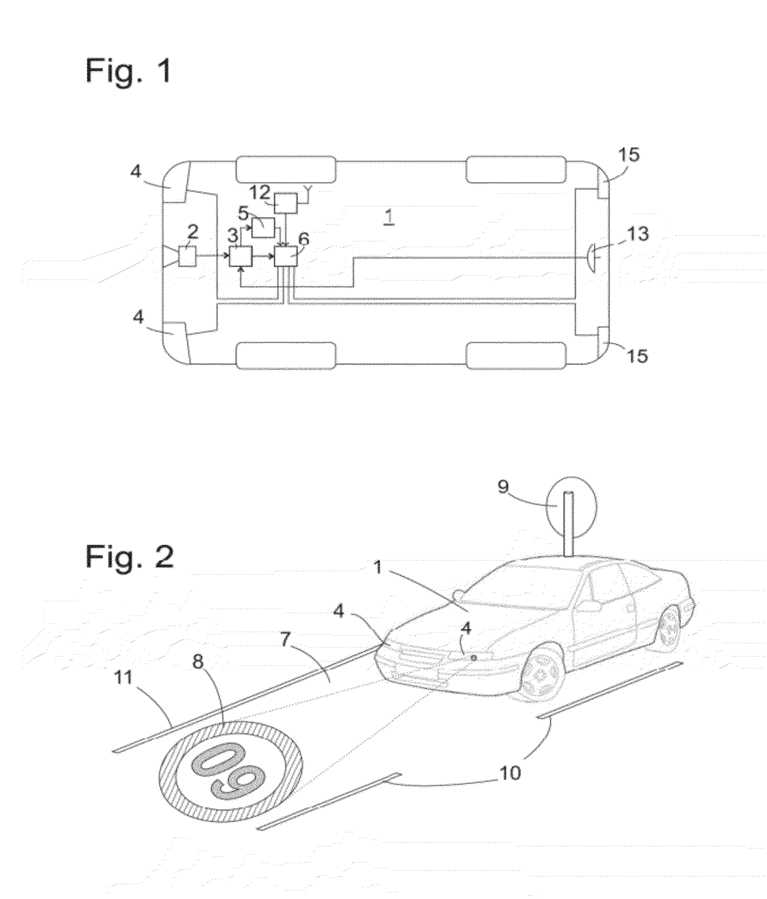

FIG. 1 shows a schematic block diagram of a motor vehicle 1 according to an embodiment of the invention. In a front region of the vehicle 1 a camera 2 aligned with a roadway located in front of the vehicle is mounted. The camera 2 supplies images of the roadway and its surroundings to an image evaluation unit 3, which is designed in a received image to identify on the one hand a traffic sign and on the other hand identify a surface suitable as projection surface. Suitable as projection surface is more preferably a surface located within the range of headlamps 4 of the vehicle 1 and comprises a substantially homogeneous reflectivity, such as for example the roadway surface located in front of the vehicle, a wall, the rear of a vehicle travelling ahead or the like.

Messages relating to an identified traffic sign will be sent to a log book unit 5 by the image evaluation unit 3; messages, relating to the position of an identified projection surface, will be sent to an image generator unit 6 by the image evaluation unit 3. The log book 5 carries out a comparison of the received traffic sign information with stored information regarding traffic signs already detected previously. If the newly detected traffic sign is a road prohibition such as for example overtaking prohibition it is stored in the log book unit 5. If the newly detected traffic sign cancels a previously detected road prohibition, the stored road prohibition is deleted. If the detected traffic sign is a speed restriction, such is stored in the log book unit 5 in place of a speed restriction possibly stored previously.

According to a simple configuration the log book unit 5 continuously supplies an information relating to the stored traffic signs to the image generator unit 6. According to a further developed configuration the log book unit 5 is set up to carry out a relevance check for example by comparing a stored speed restriction with a speedometer signal and supplies the stored traffic sign information to the image generator unit 6 only if it is evaluated as relevant, i.e. if for example the speedometer signal indicates a contravention of the speed restriction or the vehicle speed is so high that there is an immediate risk of a contravention.

In the image generator unit 6 a plurality of standard images are stored for each headlamp 4, which, if projected by the headlamp 3 concerned, correspond to a high beam or low beam light distribution. The selection of the standard image to be used at a given time can be performed by the driver in a conventional manner by means of a switch or also by the image evaluation unit 3 as a function of whether the latter detects oncoming traffic in the images supplied by the camera 2 or not.

By means of the messages supplied by the image evaluation unit 3 and relating to the position of a projection surface in front of the vehicle the image generator unit 6 selects a region in the respectively active standard image onto which the standard image and information to be projected can be superimposed. Position and size of this region in the standard image are determined in each case so that the information to be projected can fit into the detected projection surface area.

When the log book unit 5 of the image generator unit 6 signals a traffic sign to be projected, the image generator unit 6 selects an image of the traffic sign concerned from an internal image data set and superimposes the latter over the standard image in the region corresponding to the projection surface. Thus, as shown in FIG. 2, a projected speed restriction sign 8 for example appears on a roadway portion 7 in front of the vehicle 1 identified as projection surface if the image evaluation unit 3 has previously identified a corresponding sign 9 on the roadway shoulder and the vehicle 1 travels faster than is permissible according to this speed restriction. Alternatively, a projected overtaking prohibition sign could also appear on the roadway portion 7, if an entry in the log book unit 5 indicates that an overtaking prohibition applies to the road currently being travelled on and the image evaluation unit 3 detects a critical approach of the vehicle 1 to a median strip 10 of the roadway or crossing the median strip 10.

The brightness with which the image of the traffic sign 8 is superimposed on the standard image can be variably according to a further development. The image evaluation unit 3 is set up in order to detect the projected image of the traffic sign 8 in the image supplied by the camera 2 and evaluate its brightness. If the brightness proves to be inadequate for a safe detection of the traffic sign 8 by the driver, the image generator unit 6 increases the brightness of the image of the traffic sign. Thus, within the limits of the luminous power of the projector, a good detectability of the traffic sign 8 is ensured independently of the distance of the projection surface from the projector and from the reflection capacity of the projection surface.

According to a second configuration of the invention the image evaluation unit 3 can also be used in order to continuously monitor the distance of the vehicle 1 from the median strip 10 and/or a shoulder demarcation line 11 and, if this distance fluctuates according to a predetermined pattern, infer a lack of attention of the driver and send a message to this effect to the image generator unit 6. Said image generator unit 6 subsequently projects a symbol assigned to this message, for example the image of a coffee cup, in order to suggest to the driver that he should take a break. An evaluation of the driver attention can also be based on other known criteria such as for example the evaluation of steering movements or eye movements of the driver; an image evaluation unit may not be necessary in such a case.

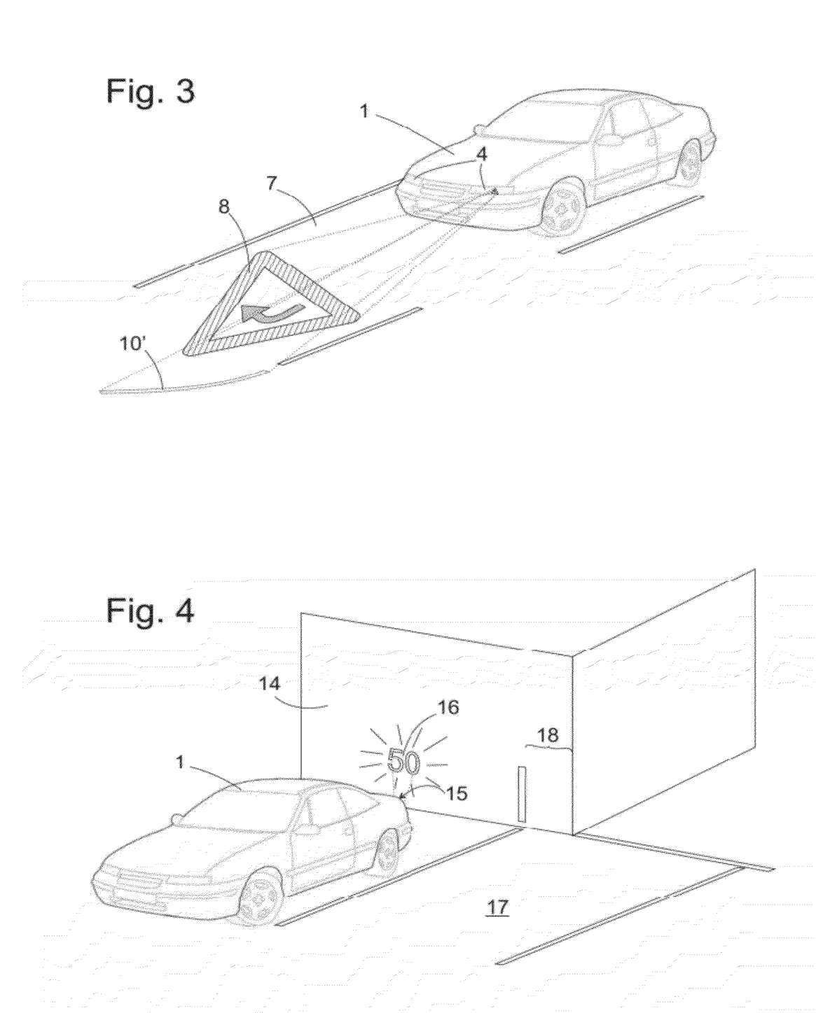

According to a third configuration of the invention a navigation system 12 is connected to the image generator unit 6 in place of the components 2, 3, 5 or cumulatively with these. The mode of operation of a motor vehicle navigation system is generally known and need not be described in more detail here. It is only substantial to the present invention that the navigation system by means of map data carried along and position information received by radio continuously generates instructions to the driver which inform him to an imminent need for turning off or other steering maneuvers. While most conventional navigation systems output such instructions on a built-in monitor or through speech synthesis, the navigation system 12 sends such instructions to the image generator unit 6. The latter reacts to this as to a traffic sign information received from the log book unit 5 by selecting and projecting a symbol corresponding to the transmitted instruction onto the projection surface. Thus, as shown in FIG. 3, a projected information sign 8 with an arrow to the right appears on the roadway 7 in front of the vehicle 1 if the vehicle 1 is to shortly turn into a road located on the right hand side.

Alternatively to the turn-off sign 8 or in addition to this, a “virtual” lane limitation 10′ as likewise shown in FIG. 3 can also be projected by the headlamps 4, the course of which suggests to the driver a turning-off or a lane change in the direction deemed necessary by the navigation system. Such a virtual roadway limitation can for example be projected in yellow color corresponding to the roadway markings customarily used on construction sites. An irritation of other drivers through such a virtual marking 10′ need not be expected since because of the grazing projection direction it is hardly noticeable to oncoming traffic and the projecting vehicle itself blocks the view of the driver of a following vehicle of the projecting marking.

According to a fourth configuration of the invention, which can be realized in combination with those explained before or also on its own, the image evaluation unit 3 is furthermore designed in order to calculate the distance to an obstacle located in front of the vehicle from the images supplied by the camera 2 or from stereoscopically overlapping images of the camera 2 and a further camera not shown in FIG. 1. Analogously, one or two cameras or, as shown in FIG. 3, a radar system 13 can be arranged on the rear of the vehicle and be connected to the image evaluation unit 3 in order to sense obstacles behind the vehicle 1. The image evaluation unit 3 selects as source of the data evaluated by it the camera 2, when the vehicle travels forward or a forward gear is engaged, or the radar system 13, when the vehicle travels backwards or a reverse gear is engaged.

FIG. 4 shows an application situation in which the vehicle 1 travels backwards towards a wall 14, for example of an underground garage. In this situation the image evaluation unit 3 evaluates data supplied by the radar system 13, for example 50 cm, and signals the corresponding numerical value to the image generator unit 6, which subsequently fades in a corresponding symbol in the image projected by at least one rear spotlight 15 (see FIG. 1) of the vehicle 1. Since here the wall 14 fills out the entire space angle that can be illuminated by the rear spotlight 15 and forms a suitable projection surface, the image generator unit 6 places the symbol to be projected in an upper region of the standard image to be projected by the spotlight 15 so that the projected distance information 16 appears at a height of a rear window of the vehicle 1 at a location of the wall 14 which is clearly visible to the driver looking through the rear window.

The wall 14 extends behind a parking space 17 adjacent to the vehicle 1 only over a part of the width of said parking space. If the vehicle 1 would attempt to park in this parking space 17 the image evaluation unit would identify the portion 18 of the wall 14 located behind the parking space 17 as suitable projection surface and thus fade in the distance information in the image projected by the rear spotlight 15 located most closely adjacent to the wall 14, so that it appears on the portion 18 of the wall 14.

Carrying out a distance measurement by means of images supplied by the camera 2 is practical according to a further configuration even when the vehicle is travelling at full speed. The image evaluation unit 3 in this manner continuously determines the distance to a vehicle travelling ahead and a part of its rear area suitable as projection surface. The measured distance is compared to a minimum distance predetermined as a function of the speed of the vehicle 1 and if the minimum distance is undershot, the image evaluation unit 2 initiates the image generator 6 to project a warning signal onto the selected region of the rear area of the vehicle travelling ahead.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A motor vehicle, comprising:
a digital projector for configured to project information; and
a monitoring circuit connected to the digital projector configured to determine the information in real time for projection by the monitoring circuit.

2. The motor vehicle according to claim 1, wherein the information is graphic information.

3. The motor vehicle according to claim 1, wherein the information is type-facial information.

4. The motor vehicle according to claim 1, wherein the digital projector is configured to project the information in a direction away from a passenger cell.

5. The motor vehicle according to claim 1, wherein the digital projector is a headlamp.

6. The motor vehicle according to claim 1, wherein the digital projector is a rear spotlight.

7. The motor vehicle according to claim 1, wherein the digital projector is a headlamp and a rear spotlight and the motor vehicle further comprising:
a control unit configured to:
select the headlamp for projecting the information when the motor vehicle moves forward; and
configured to select the rear spotlight for projecting the information when the motor vehicle moves backwards.

8. The motor vehicle according to claim 1, wherein the digital projector is a headlamp and a rear spotlight and the motor vehicle further comprising:
a control unit configured to:
select the headlamp for projecting the information when a forward gear is engaged; and
configured to select the rear spotlight for projecting the information when a reverse gear is engaged.

9. The motor vehicle according to claim 1, wherein the information determined in real time is a distance of the motor vehicle from an obstacle.

10. The motor vehicle according to claim 1, wherein the monitoring circuit comprises a navigation system and the information determined in real time is an output of the navigation system.

11. The motor vehicle according to claim 10, wherein the output of the navigation system is a driving direction.

12. The motor vehicle according to claim 1, wherein the digital projector is configured to project the information in a form of an image of a traffic sign.

13. The motor vehicle according to claim 1, wherein the digital projector is configured to project the information in a form of a lane marking.

14. The motor vehicle according to claim 1, wherein the monitoring circuit is configured to monitor an attention of a driver.

15. The motor vehicle according to claim 1, wherein the information determined by the monitoring circuit and projected by the digital projector specifies a restriction of navigability of a road travelled on by the motor vehicle.

16. The motor vehicle according to claim 15, wherein the monitoring circuit is configured to evaluate if the motor vehicle is in a process of contravening a restriction and to project the information specifying the restriction only in event of a contravention.

17. The motor vehicle according to claim 1, further comprising:
a detector that is configured to detecting a vehicle-external projection surface; and
an alignment apparatus configured to align a projection direction with a detected projection surface.

18. The motor vehicle according to claim 17, wherein the digital projector comprises a matrix with a plurality of individually activatable and light-modulating elements, and the alignment apparatus configured to align the projection direction and set up to select a group of the plurality of individually activatable and light-modulating elements supplied with the information according to a desired projection direction.

19. The motor vehicle according to claim 17, wherein the alignment apparatus is configured to detect an obstacle as a projection surface.

20. The motor vehicle according to claim 7, further comprising a sensor configured to sense a brightness of a projection surface and the control unit is further configured to control a light intensity with which the information is projected based at least in part on the light intensity.
